(19) United States
(12) Patent Application Publication
(10) Pub. No.: US 2023/0191413 A1
(43) Pub. Date: Jun. 22, 2023

(54) METHOD AND APPARATUS FOR MEASURING PHASE TRANSITION CHARACTERISTICS OF MACROMOLECULES

(71) Applicant: CAMBRIDGE ENTERPRISE LIMITED, Cambridge, Cambridgeshire (GB)

(72) Inventors: William E. ARTER, Cambridge, Cambridgeshire (GB); Georg KRAINER, Cambridge, Cambridgeshire (GB); Timothy WELSH, Cambridge, Cambridgeshire (GB); Runzhang QI, Cambridge, Cambridgeshire (GB); Tuomas P.J. KNOWLES, Cambridge, Cambridgeshire (GB)

(21) Appl. No.: 17/999,478

(22) PCT Filed: May 21, 2021
(86) PCT No.: PCT/GB2021/051243

§ 371 Date: Nov. 21, 2022

(30) Foreign Application Priority Data
May 22, 2020 (GB) 2007689.9

(51) Int. Cl. B01L 3/00; G01N 21/53; G01N 21/64; G01N 21/03; G01N 21/05

(52) U.S. Cl. CPC B01L 3/502784; G01N 21/53; G01N 21/6458; G01N 21/0332; G01N 21/6428; G01N 21/05; G01N 2021/513

(57) ABSTRACT

A method measuring the phase transition characteristics of a macromolecule, the method comprising: generating a stream of micro-droplets comprising at least one constituent, of which one constituent comprises the macromolecule, varying the conditions in the micro-droplets; and measuring the relative concentrations of the constituents of, and the phases of the macromolecule present in, the micro-droplets.

The project leading to this application has received funding from the European Union's Horizon 2020 research and innovation programme under the Marie Sklodowska-Curie grant agreement No 841466.

The present invention relates to a method and apparatus for measuring phase transition characteristics of macromolecules. A specific example of the present invention relates to liquid-liquid phase separation (LLPS).

Liquid-liquid phase separation (LLPS), the spontaneous demixing of macromolecular solutions (e.g. macromolecular polymer solutions such as proteins, peptides, and nucleic acids) into coexisting condense and dilute phases, has become the subject of intense interest due to the newly-realised importance of this process in regulating biological function. For example, phase-separated protein (e.g. biomolecular protein) condensates discretise and organise cellular space, and act as microreactors by localising biomolecules. Condensates are crucial to a diverse range of elementary biochemical processes, including regulation of transcription, translation, the modulation of cellular stress responses. They are also heavily implicated in protein misfolding diseases, including motor neuron disease as well as cancer pathogenesis, making them an attractive target for therapeutic intervention.

Phase separation, now established for hundreds of cellular proteins, and other biological macromolecules (including nucleic acids and peptides), can be triggered by minute changes in environmental conditions such as fluctuations in ionic strength, pH, temperature, molecular crowding, and the presence of small molecules. Because of this sensitivity to physicochemical parameters, many phase separating systems are currently receiving intense interest as fundamentally novel drug targets to ameliorate human diseases. However, there is currently an unmet need to quantify the physical parameters that modulate phase separation behaviour in condensate systems.

A fundamental measure with which to describe the thermodynamics of condensate systems is the phase diagram, as generated by systematic analysis of the presence or absence of LLPS as a function of macromolecule concentration and solution conditions. Phase diagrams eloquently summarise the phase-behaviour of LLPS systems, by elucidating the position of chemical equilibrium between the LLPS and homogeneous regimes by determining the position of the phase boundary in chemical space. Varying the solution conditions in an LLPS system can directly change the phase boundary and thus afford insight into the thermodynamic processes driving biomolecular condensation. As such, the generation of phase diagrams is a vital step to an understanding of macromolecule phase-separation behaviour.

However, given the large variety of proteins undergoing LLPS and the environmental conditions which regulate their behaviour, there is a pressing need for experimental methods that enable rapid and high-resolution characterisation of LLPS phase diagrams. Typically, these are generated by wasteful and laborious methods involving stepwise combination of reagents to create the requisite variation in solution conditions, and observation of individual conditions by microscopy. Microfluidic techniques are now established as an effective means to improve assay throughput, parallelisation and miniaturisation in biochemical experiments, and have found recent application in the quantification of biomolecular phase-behaviour on chip. However, no technique has yet been demonstrated for the rapid, high throughput generation of LLPS phase diagrams.

Known methods of assaying the phase-behaviour of LLPS systems in the presence of drug candidates are performed manually, or with the assistance of robotics, using multiwell-plates to conduct reactions under different conditions. However, this approach is too slow. The best automated/robotic multi-well plate assays limited to less than 100,000 conditions/day.

The present invention aims to at least partially solve the above problems. For example, embodiments of the present invention may provide much faster data acquisition than current techniques in context of phase separation, higher resolution data, significantly lower reagent consumption and, directed-feedback from real-time data acquisition.

According to an aspect of the invention there is provided method measuring the phase transition characteristics of a macromolecule, the method comprising: generating a stream of micro-droplets comprising at least one constituent, of which one constituent comprises the macromolecule, varying the conditions in the micro-droplets; and measuring the relative concentrations of the constituents of, and the phases of the macromolecule present in, the micro-droplets.

Optionally the conditions in the micro-droplets are varied by varying the relative concentrations in the micro-droplets of the constituent comprising the macromolecule and at least one further constituent.

Alternatively, or additionally, the conditions in the micro-droplets are varied by varying the temperature of the micro-droplets. Optionally the temperature of the micro-droplets are varied by controlling the temperature of a channel in which the micro-droplets flow.

According to an aspect of the invention there is provided a method of measuring phase transition characteristics of a macromolecule, the method comprising: generating a stream of micro-droplets comprising at least two constituents, of which one constituent comprises the macromolecule, the micro-droplets comprising the same constituents in varying relative concentrations; and measuring the relative concentrations of the constituents of, and the phases of the macromolecule present in, the micro-droplets.

Optionally, the stream of micro-droplets is a continuous stream.

Optionally, the measuring is performed continuously on the stream of micro-droplets.

Optionally, the micro-droplets are collected and measuring is performed on the collected micro-droplets.

Optionally, the stream of micro-droplets is generated by injecting a stream of a first fluid comprising the at least two constituents into a stream of a second fluid, the second fluid being immiscible with the first fluid.

Optionally, respective streams of the at least two constituents of the micro-droplets join to form the stream of the first fluid.

Optionally, the relative concentrations of the constituents of the micro-droplets are varied by varying relative flow rates of the respective streams of the at least two constituents of the micro-droplets.

Optionally, the streams flow in channels of a microfluidics system.

Optionally, the relative concentrations of the constituents of the micro-droplets are measured by a first optical means. Optionally, the first optical means illuminates the micro-droplets with illumination light and detects a response. Optionally, the relative concentrations of the constituents of the micro-droplets are determined based on the respective responses of the constituents to the illumination light. Optionally, each of the constituents responds differently to the illumination light. Optionally, each of the constituents comprises a different fluorophore which emits light of a specific wavelength in response to the illumination light.

Optionally, the phases of the macromolecule present in the micro-droplets are measured by a second optical means. Optionally, the second optical means obtains images of the micro-droplets and the phases of the macromolecule present in the micro-droplets are determined based on characteristics of the image indicative of particular phases. Alternatively, the second optical means obtains a light-scattering profile of the micro-droplets and the phases of the macromolecule present in the micro-droplets are determined based on characteristics of the light scattering profile indicative of particular phases.

Optionally, the relative concentrations of the constituents of the micro-droplets are varied based on the measured relative concentrations of the constituents of, and the phases of the macromolecule present in, the micro-droplets.

Optionally, the relative concentrations of the constituents of the micro-droplets are systematically varied so as to generate micro-droplets having conditions at which, or substantially close to which, the macromolecule transitions from a first phase to a second phase.

Optionally, the further comprises analysing the measurements to determine at which the macromolecule transitions from a first phase to a second phase.

Optionally, the macromolecule comprises one or more of: a protein, and a nucleic acid. Optionally, the at least two-constituents further comprise one or more of: a pH buffer, a phase separator, a salt solution and a therapeutic drug/drug candidate. Optionally, the therapeutic drug/drug candidate is a small molecule or biologic.

According to a second aspect of the invention there is provided a method of screening therapeutic drug candidates, the method comprising the steps of the method of the preceding aspect, wherein at least one constituent of the micro-droplets, other than the macromolecule, comprises a drug candidate. Optionally, therapeutic drug candidates that fail to change the phase transition characteristics in a predefined desired way are discarded.

According to a third aspect of the invention there is provided an apparatus for measuring phase transition characteristics of a macromolecule, the apparatus comprising: a microfluidics system configured to generate a stream of micro-droplets comprising at least two constituents, of which one constituent comprises the macromolecule, and vary the relative concentrations of the constituents; a first optical system configured to measure the relative concentrations of the constituents of the micro-droplets generated by the microfluidics system; and a second optical system configured to measure the phases of the macromolecule present in the micro-droplets generated by the microfluidics system.

Optionally, the first and second optical systems are configured to continuously measure the stream of micro-droplets. Optionally, the first and second optical systems are located adjacent a measurement region of the microfluidics system.

Optionally, the microfluidics system comprises: at least two inlets configured to input streams of respective constituents of the at least two constituents; a first channel through which a stream of a first fluid is configured to flow, the first fluid comprising the at least two constituents from the at least two inlets; and a second channel through which a stream of a second fluid is configured to flow, the second fluid being immiscible with the first fluid; wherein the first channel comprises a nozzle opening into the second channel and configured to inject the stream of the first fluid into the stream of the second fluid and generate micro-droplets of the first fluid within the second fluid.

Optionally, the apparatus further comprises at least two pumps corresponding to the at least two inlets, the at least two pumps being configured to vary the relative flow rates of the streams of the respective constituents so as to vary the relative concentrations of the at least two constituents of the generated micro-droplets.

Optionally, the apparatus further comprises a controller configured to control the pumps to vary the relative concentrations of the constituents of the micro-droplets based on the measured relative concentrations of the constituents of, and the phases of the macromolecule present in, the micro-droplets. Optionally, the controller is configured to control the pumps so as to systematically vary the relative concentrations of the constituents of the micro-droplets so as to generate micro-droplets having conditions at which, or substantially close to which, the macromolecule transitions from a first phase to a second phase.

Optionally, the first optical means comprises: a light source configured to illuminate the micro-droplets with illumination light; and a detector configured to detect the response of the micro-droplets to the illumination light. Optionally, the light source comprises a plurality of light emitting parts each configured to emit light of a different wavelength. Optionally, the detector comprises a plurality of light detection parts each configured to detect light of a different wavelength. Optionally, the apparatus further comprises a processor configured to determine the relative concentrations of the constituents of the micro-droplets based on the respective responses of the two or more constituents to the illumination light.

Optionally, the second optical means comprises an imaging element configured to obtain images of the micro-droplets. Optionally, the apparatus further comprises a processor configured to determine the phases of the macromolecule present in the micro-droplets based on characteristics of the obtained images indicative of particular phases. Alternatively, the second optical means comprises: a light source configured to illuminate the micro-droplets; and a detector configured to obtain a light-scattering profile of light from the light source scattered by the micro-droplets. Optionally, the apparatus further comprising a processor configured to determine the phases of the macromolecule present in the micro-droplets based on characteristics of the light-scattering profile indicative of particular phases.

In any preceding aspect, optionally the constituent comprising the macromolecule comprises one or more of: the macromolecule itself, a cell, a subcellular organelle, a cell lysate.

In any preceding aspect, optionally the phase transition characteristics of two or more macromolecules are measured simultaneously, at least one constituent comprising a further macromolecule.

Further features of the invention are described below by way of non-limiting example and with reference to the accompanying drawings, in which:

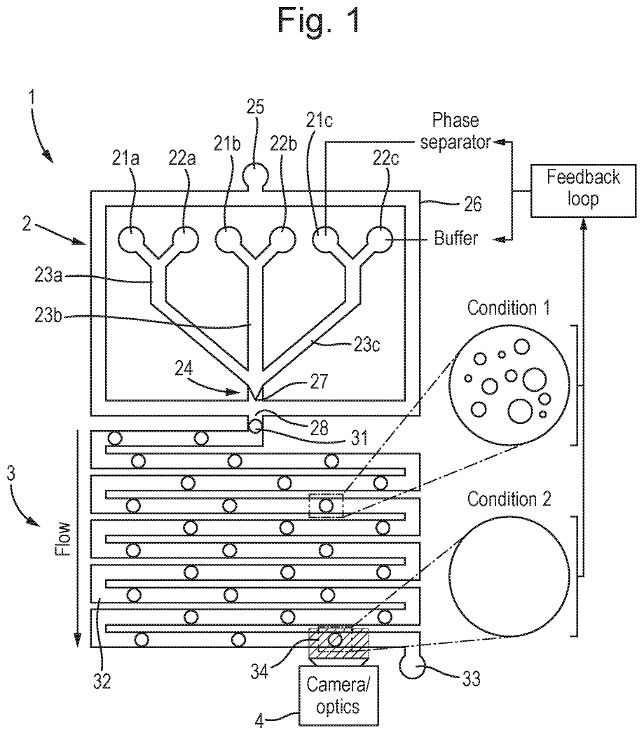

FIG. 1 schematically shows an example system according to the present invention;

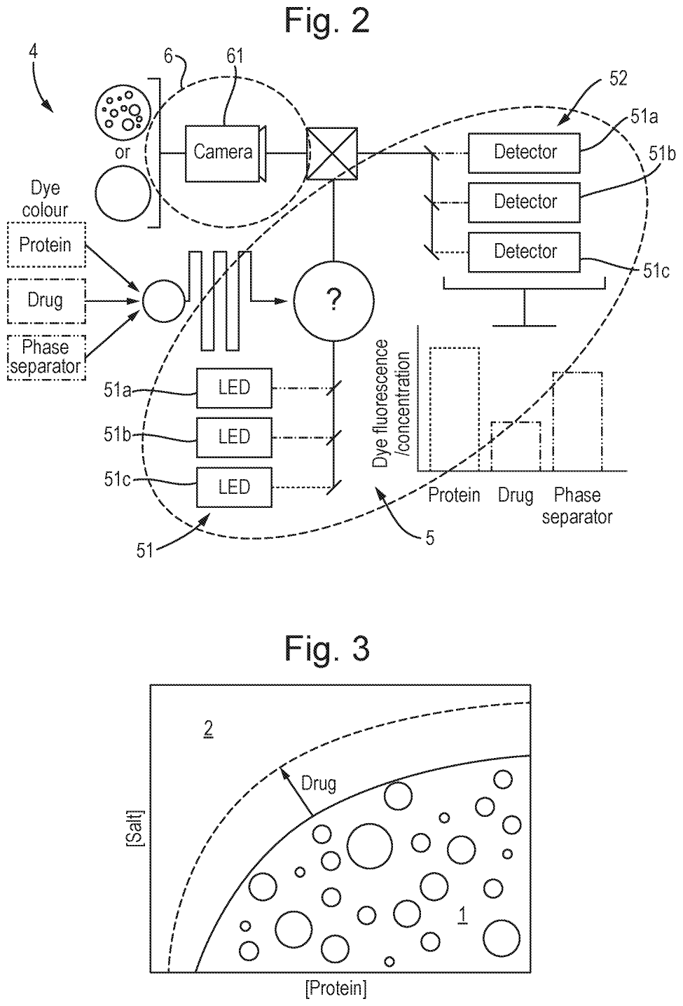

FIG. 2 schematically shows an example measurement system of an apparatus according to the present invention;

FIG. 3 is an example of a phase diagram showing the liquid-liquid phase transition as a function of salt concentration and protein concentration;

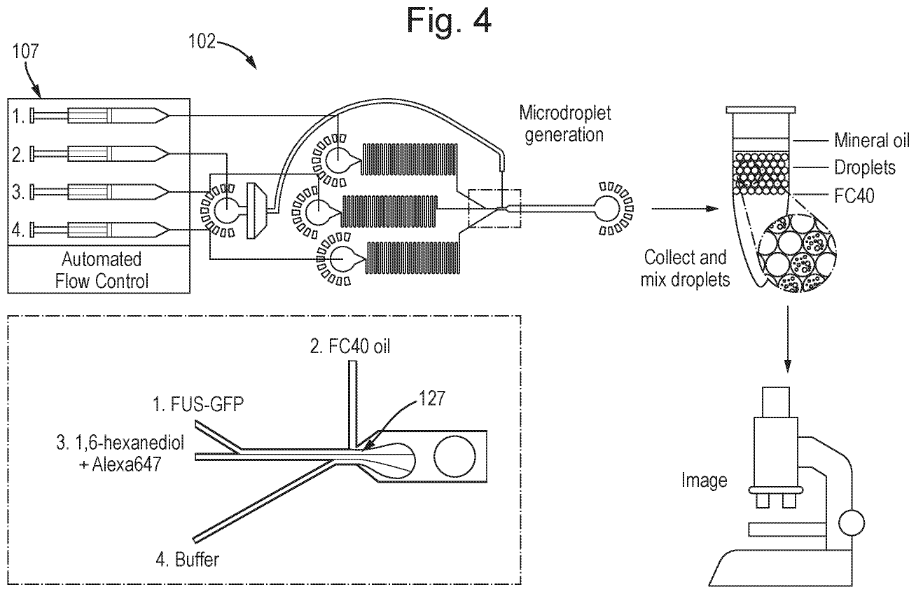

FIG. 4 schematically shows an example system according to the present invention;

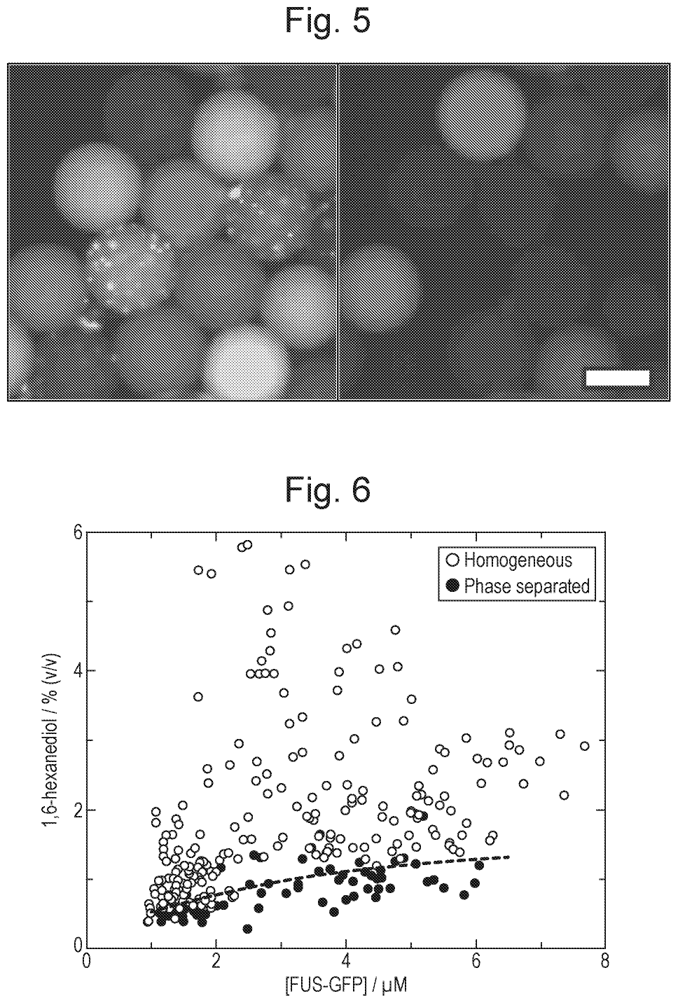

FIG. 5 shows epifluorescence microscopy images of droplets containing various concentrations of FUS-GFP (left) and 1,6-hexanediol, with the concentration of the latter indicated by coencapsulated Alexa647 fluorescence (right);

FIG. 6 shows a phase diagram for FUS-GFP as function of protein and 1,6-hexanediol concentration; points represents measured solution conditions for individual micro-droplets (N=322), with presence or absence of phase-separation indicated by hollow or filled circles, respectively; the dashed line is a guide for the eye representing the approximate position of the LLPS phase boundary;

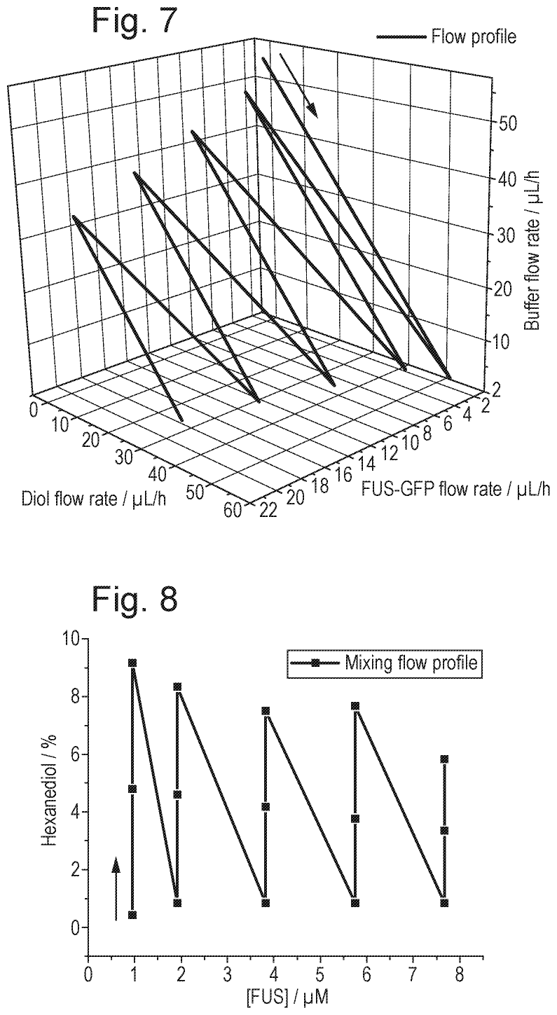

FIG. 7 shows a plot of flow rates of buffer, 10% 1,6-hexanediol and 23 uM FUS solutions;

FIG. 8 shows a plot of 1,6-hexandiol and FUS concentrations from flow rate profile shown in FIG. 7;

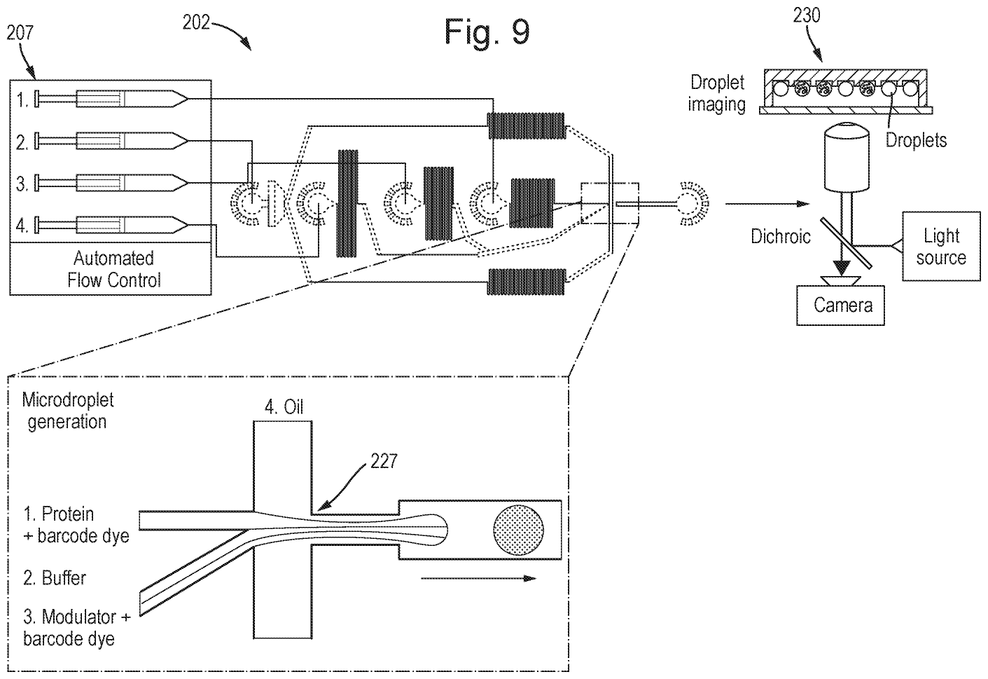

FIG. 9 schematically shows an example system according to the present invention;

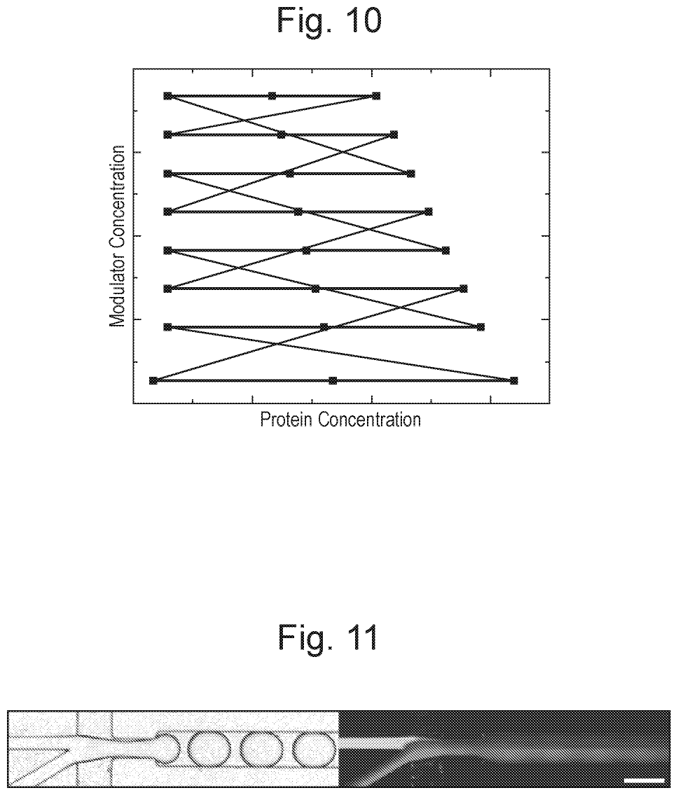

FIG. 10 shows a plot of varying flow rates;

FIG. 11 shows microdroplet formation;

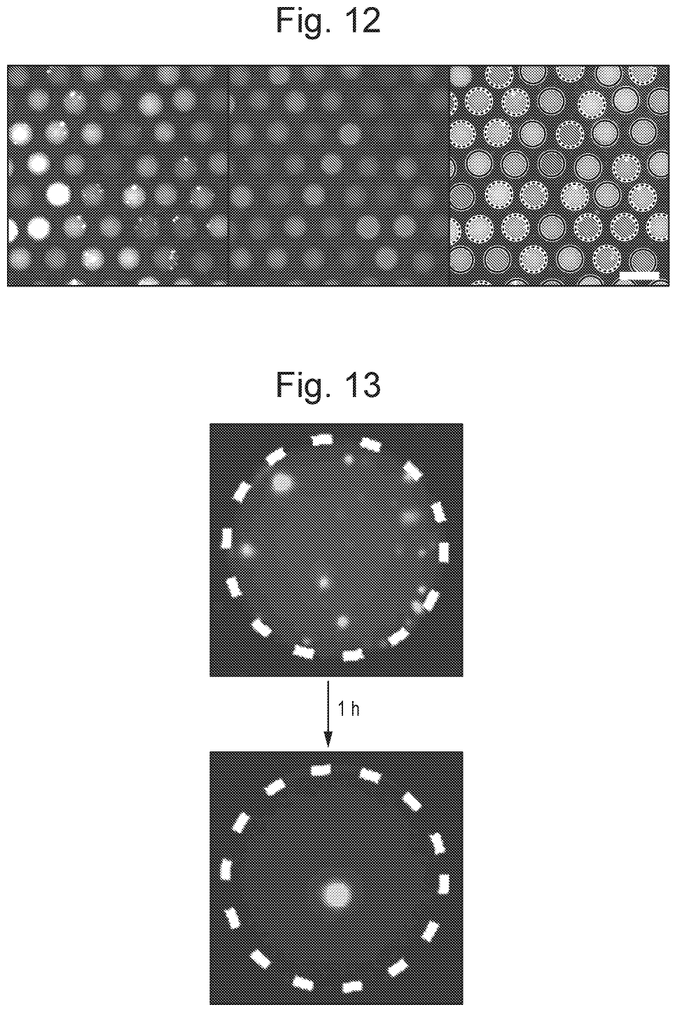

FIG. 12 shows fluorescence images showing different constituents (left, middle) and droplets with and without phase separation;

FIG. 13 shows condensates margins over time; and

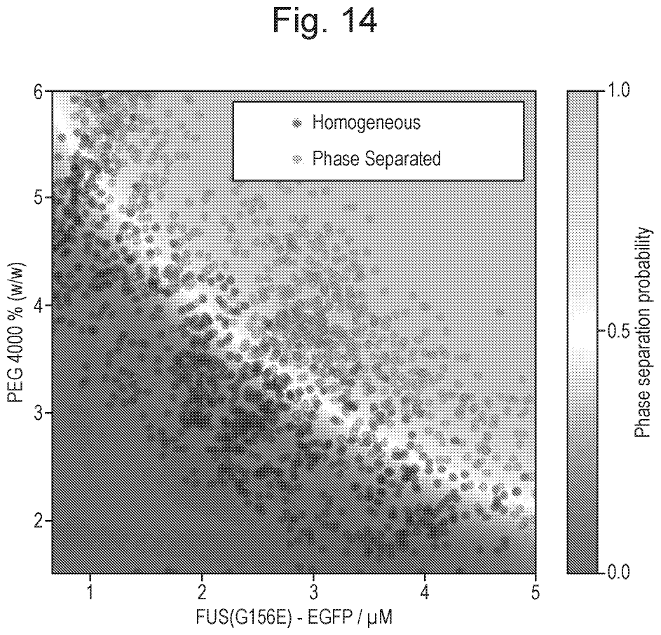

FIG. 14 shows a phase diagram obtained using the system of FIG. 9.

In order to measure phase transition characteristics of a macromolecule according to the present invention, a stream of micro-droplets is required. This stream is preferably substantially continuous, but may be intermittent or otherwise. The micro-droplets form a dispersed phase within a fluid forming a continuous phase (here “phase” is used in the context of the microfluidics system and should not be confused with the “phase” in the context of phase transition of the macromolecule). Micro-droplets generally refers to droplets having a diameter less than 1 mm and includes droplets with micrometre scale dimensions, and droplets with diameters less than 1 micrometre, i.e. nano-droplets.

The micro-droplets should comprise at least two constituents, and one constituent should comprise the macromolecule. The macromolecule is preferably a polymer and more preferably comprises one or more of a protein and a nucleic acid. The macromolecule may be part of a cell, subcellular organelle (e.g. nuclei or mitochondria) or cell lysate in some embodiments, the constituent comprising the cell, subcellular organelle or cell lysate. Further constituents may comprise one or more of: a pH buffer, a phase separator, a salt solution, cells, cell lysates and a therapeutic drug/drug candidate. As described further below, some or all of the constituents (e.g. constituents of interest whose relative concentrations are to be measured, including the macromolecule) may additionally (to the above described components) comprise an optical marker (also referred to as a “barcode”). A pH buffer may not be optically marked. Phase separators may include crowding agents (polymers of biological and non-biological origin, e.g. PEG and dextran), proteins, nucleic acids, different salts, or small molecules that induce phase separation. The therapeutic drug/drug candidate may be a small molecule or biologic, including but not limited to protein, nucleic acid, lipid, peptide, or antibody.

Further, the micro-droplets should comprise the same constituents in varying relative concentrations. To achieve this, the microfluidics system 1 shown in FIG. 1 may be used.

The example microfluidics system 1 shown in FIG. 1 comprises two main parts, namely a generation part 2 and an incubation part 3. Micro-droplets comprising the same constituents in varying relative concentrations, i.e. different reaction conditions, are generated in the generation part 2. The micro-droplets flow through the incubation part 3 for a predetermined time period, which allows the constituents to react and, possibly, the macromolecule to condense.

In the example microfluidics system 1 shown in FIG. 1, the generation part 2 comprises three constituent inlets 21a, 21b and 21c configured to input streams of respective constituents of the micro-droplets. In this example, there are three constituents, namely a first constituent comprising a protein (the macromolecule), a second constituent comprising a drug candidate, and a third constituent comprising a phase separator. In this example, each of these constituents is optically marked with a different marker. In the present example, each of these is mixed with a pH buffer input via buffer inlets 22a, 22b and 22c. However, this is optional. In this example, the pH buffer is not optically marked. It should be noted that, in alternative examples, different constituents and/or different numbers of constituents may be used.

Although not shown in the Figures, the generation part 2 may further comprise pumps corresponding to the constituent inlets 21a, 21b and 21c. The pumps may be configured to vary the relative flow rates of the streams of the respective constituents and thus vary the relative concentrations of the constituents of the micro-droplets. It should be understood that the pumps should be of the type suitable for use in a microfluidics system, e.g. micro-pumps. By use of pressure-controlled fluid flow, micro-droplet conditions can be varied on a millisecond timescale.

As shown in FIG. 1, the constituents flow through respective sub-channels 23a, 23b and 23c in communication with the constituent inlets 21a, 21b and 21c. These sub-channels 23a, 23b and 23c converge into a first channel 24. Accordingly, the first channel 24 carries a stream of a first fluid comprising all of the constituents from the inlets 21a, 21b and 21c. It should be understood that all channels referred to herein, unless otherwise stated, are micro-channels, i.e. channels having at least one dimension less than 1 mm. Of course, alternative arrangements may be used to mix the constituents together.

In the example microfluidics system 1 shown in FIG. 1, the generation part 2 further comprises a continuous-phase-inlet 25 configured to input a stream of second fluid (the first fluid comprising all of the constituents). The second fluid forms a continuous phase in which the micro-droplets are to be dispersed. The second fluid may be immiscible with the first fluid. For example, the first fluid may be an aqueous solution and the second fluid may be an oil, such as fluorinated oil. The second fluid may optionally comprise a surfactant.

As shown in FIG. 1 the continuous-phase-inlet 24 is in communication with a second channel 26 through which a stream of a second fluid is configured to flow. Although in FIG. 1 the second channel 26 is in the form of a loop, with the second fluid flowing in two opposing directions from the continuous-phase-inlet 25, the second channel 26 may have a different form. For example, the second channel 26 may be linear (i.e. the second fluid may be constrained to flow along a single path, but that path is not necessarily a straight line). Of course, alternative arrangements may be used instead.

As shown in FIG. 1, the first channel 24 comprises a nozzle 27 opening into the second channel 26. The nozzle 27 is configured to inject the stream of the first fluid into the stream of the second fluid and generate micro-droplets of the first fluid (dispersed phase) within the second fluid (continuous phase). Of course, alternative arrangements may be used to mix the first and second fluids to form micro-droplets.

As shown in FIG. 1, the second channel 26 comprises an opening 28. As shown, this opening may be opposite to the nozzle 27. However, other arrangements may be used instead. The opening 28 is in communication with the incubation part 3 of the microfluidics system 1 and is configured to allow the micro-droplets to flow from the generation part 2 into the incubation part 3.

As shown in FIG. 1, the incubation part 3 comprises an inlet 31 in communication with the opening 28 of the second channel, a third channel 32, and an outlet 33. The outlet 33 is configured to remove the first and second fluids from the micro-fluidics system 1. A measurement region 34 of the third channel 32 is located upstream of the outlet 33. The measurement region 34 is the location at which the micro-droplets are analysed. For reasons that will become apparent below, at least the measurement region 34 of the microfluidics system 1 may be transparent.

The third channel 32 is configured to have a predetermined length from the inlet 31 to the measurement region 34. This predetermined length, for a given flow rate of micro-droplets through the third channel 32, determines the incubation time of the micro-droplets before any measurements are made. The incubation time may be from 10 ms to 10 minutes, or preferably from 1 to 20 seconds, for example. In order to minimize the size of the microfluidics system, the third channel 32 may have a serpentine shape as show in FIG. 1. However, alternative arrangements may be used instead.

As shown in FIG. 1, the third channel 31 may be linear (in the sense that the micro-droplets are constrained to flow along a single path, but that path is not necessarily physically a straight line). However, alternative arrangements may be used. For example, the third channel 31 may split into any number of parallel channels (in the sense that micro-droplets flow in each channel simultaneously, like a parallel electrical circuit, but the channels are not necessarily physically parallel to each other). Each parallel channel may comprise its own measurement region allowing multiple sets of measurements to be taken in parallel, thus further increasing throughput. In this example, the parallel channels may converge upstream of the outlet 33 or remain split and each have their own corresponding outlet.

The system may further comprise means for controlling the temperature within the third channel 32. For example, the incubation part may comprise a heater, such as a heat block, or an incubation chamber for the microfluidic device 1. In some example systems, the temperature may be the only variable. That is, the temperature maybe varied, but not the relative concentrations of constituents of the micro-droplets. Accordingly, the behaviour of a macromolecule at different temperatures may be measured.

In order to measure phase transition characteristics of a macromolecule according to the present invention, measurement of the relative concentrations of the constituents of the micro-droplets is required. Imaging may be performed on stationary droplets, e.g. using standard epifluorescence microscopy techniques, e.g. by (i.) trapping of the droplets on chip, whether this is the same or a different device to that used for droplet generation or (ii) imaging of droplets outside of microfluidic environment e.g. in arrays or reservoirs, such as in multiwell plates or on cover slide. However, this measurement is preferably performed continuously on the stream of micro droplets. To achieve this, the measurement system 4 shown in FIG. 2 may be used.

In the example measurement system 4 shown in FIG. 2, the relative concentrations of the constituents of the micro-droplets are measured by a first optical system 5. Using optical means may help to provide a higher throughput, by increasing detection speed. The measurement system shown in FIG. 2 is configured for use with a microfluidics system in which some or all of the constituents of the micro-droplets may comprise a different optical marker, such as a fluorophore. Fluorophores may comprise small-molecule fluorochromes, macromolecular fluorescent proteins such as GFP, RFP, or fluorescent particles such as quantum dots. Each fluorophore may be configured to emit light of a specific wavelength when illuminated. As shown in FIG. 2, the first optical system 5 comprises a light source 51 and a detector 52.

The light source 51 is configured to illuminate the micro-droplets with illumination light. As shown, the light source 51 comprises a plurality (three in this case) of light emitting parts 51a, 51b and 51c. Each of the light emitting parts 51a, 51b and 51c is configured to emit light of a different wavelength. The light emitting parts 51a, 51b, 51c may each be configured to emit light substantially having a single wavelength, e.g. laser light. The light emitting parts 51a, 51b, 51c may comprise LEDs, for example.

The wavelengths of the light emitting parts 51a, 51b and 51c may correspond to wavelengths absorbed by respective fluorophores associated with each optically marked constituent of the micro-droplets. The wavelengths may correspond to red, green and blue visible light, for example. However, any wavelengths may be used. Suitable optical elements, such as lenses, mirrors or optical fibres may be used to direct the emitted light from light emitting parts 51a, 51b, 51c.

The detector 52 is configured to detect the response of the micro-droplets to the illumination light. As shown, the detector 52 may comprise a plurality (three in this case) of light detecting parts 52a, 52b, 52c corresponding to the plurality of light emitting parts 51a, 51b, 51c. The light detecting parts 52a, 52b, 52c may comprise photodiodes. The light detecting parts 52a, 52b, 52c may optionally comprise one or more filters for separating the received light into light of different wavelengths for detection. The wavelengths detected by light detecting parts 52a, 52b, 52c may correspond to wavelengths emitted by the fluorophores associated with each constituent of the micro-droplets. Suitable optical elements, such as lenses, mirrors or optical fibres may be used to direct the received light to the light detecting parts 52a, 52b, 52c.

The relative concentrations of the constituents of the micro-droplets can be determined based on the respective detected responses of the constituents to the illumination light. Assuming suitable calibration, according to the example shown in FIG. 1, the relative concentrations can be determined based on the relative signals output by the light detecting parts 52a, 52b, 52c. Some processing of the raw data, e.g. by a processor, may be required to determine the relative concentrations of the constituents of the micro-droplets.

In order to measure phase transition characteristics of a macromolecule according to the present invention, measurement of the phases of the macromolecule present in the micro-droplets is required. To achieve this, the measurement system 4 shown in FIG. 2 may be used.

In the example measurement system 4 shown in FIG. 2, the phases of the macromolecule present in the micro-droplets are measured by a second optical system 6. Using optical means may help to provide a high throughput. As shown in FIG. 2, the second optical system 6 comprises an imaging element 61 configured to obtain images of the micro-droplets. This may include obtaining fluorescence and/or bright-field images. The imaging element 61 may comprise a high-speed camera, for example. In the example shown in FIG. 2, the phases of the macromolecule present in the micro-droplets are determined based on characteristics of the obtained images indicative of particular phases. This image processing may be performed by a processor (e.g. the same processor as described above in relation to measuring relative concentrations of the constituents of the micro-droplets). The image processing may include pattern recognition algorithms and/or machine learning algorithms.

In an alternative example not shown in the Figures, the second optical system may comprise a light source configured to illuminate the micro-droplets, and a detector configured to obtain a light-scattering profile of light from the light source scattered by the micro-droplets. For example, the second optical system may be an interferometric scattering microscopy system. The phases of the macromolecule present in the micro-droplets may be determined based on characteristics of the light-scattering profile indicative of particular phases. This image processing may be performed by a processor (e.g. the same processor as described above in relation to measuring relative concentrations of the constituents of the micro-droplets). The image processing may include pattern recognition algorithms and/or machine learning algorithms.

Data obtained by the measurements described above, namely the relative concentrations of constituents and the macromolecule phases present for each micro-droplet that is analysed, may be stored in a memory, e.g. RAM. The data may be stored in tabular form with rows representing each analysed droplet and with columns for the concentrations of constituents and the macromolecule phases present/not present.

The obtained data may be analysed to determine a phase boundary of the macromolecule in chemical-space. In other words, the chemical conditions (relative concentrations of constituents) at which the macromolecule transitions from a first phase to a second phase may be determined. The phase boundary can be determined by any suitable mathematical method, many of which are well known in the art. For example, a regression curve can be mathematically determined based on the data, the regression being weighted towards data points that are closely adjacent data points for a different phase.

In order to obtain data points in chemical-space, the relative concentrations of the constituents of the micro-droplets may be systematically varied. This variation may be predetermined, following a predefined path in chemical space, or may be dynamic, based on real-time data, as described further below.

In one specific example of predetermined variation of the relative concentrations of the constituents of the micro-droplets, concentrations of constituents may be varied cyclically between minimum and maximum concentrations. Further, the concentrations of at least two different constituents may be varied cyclically with different periods. The period may be measured in time or number of micro-droplets i.e. data points. The period may remain constant or vary between cycles. The minimum and maximum values may also vary between cycles. This can be achieved by pre-programming the flow-control system that controls fluid flow to the microfluidic system, (e.g. a syringe-driver or pressure-control system, etc.). The control system may be programmed directly by the device or itself controlled by an external computer. The system may be controlled to cyclically vary the relative flow rates of the constituents while keeping the total flow rate constant. This may ensure homogenous droplet generation.

Accordingly, as shown in FIGS. 7 and 8, a surface, or volume in chemical space can be scanned. As shown in FIGS. 7 and 8, data points in chemical space may be generated with respect to a first axis in chemical space (e.g. concentration of first constituent) with a short period and with respect to a second axis in chemical space (e.g. concentration of second constituent) with a long period, thus scanning a two-dimensional surface in chemical space. The concentrations of some different constituents may be varied with the same period. Accordingly, the relative concentrations of said different constituents can be kept constant. For example, as shown in FIG. 7, the relative concentrations of buffer to diol remain constant.

The determined phase boundary may be used to generate a phase diagram, such as the phase diagram shown in FIG. 3. In FIG. 3, the top left portion represent a homogenous liquid phase and the bottom right portion represents a condensed liquid phase. FIG. 3 also shows how the phase boundary can be shifted (in the direction of the arrow) by the presence of a drug.

The data processing may be performed by a processor. The processor may be the same processor described above in relation to measuring the relative concentrations of the constituents of the micro-droplets and measuring the phases present in the micro-droplets.

All of the above described processing may be performed in real-time, i.e. as the micro-droplets are being generated and the measurements are made. Accordingly, the relative concentrations of the constituents of the micro-droplets may be varied based on the measured relative concentrations of the constituents of, and the phases of the macromolecule present in, the micro-droplets. Such a feedback loop is shown in FIG. 1.

In one specific example, the process may start by varying the relative concentrations of constituents of the micro-droplets in a predefined manner, following a predefined path in chemical-space, e.g. as described above in relation to FIGS. 7 and 8. As data is obtained and analysed, the path in chemical-space may be modified based on the analysed data to substantially converge with a determined phase boundary. In other words, relative concentrations of the constituents of the micro-droplets may be systematically varied to generate micro-droplets having conditions at which, or substantially close to which, the macromolecule transitions from a first phase to a second phase. In this way, the most useful data points, i.e. those closest to a phase boundary can be obtained more efficiently. This further helps to improve throughput. This may be achieved by adjusting the minimum and/or maximum concentrations, and/or periods of the cyclically varying concentration described above. For example, concentration range defined by the minimum and maximum concentrations may be narrowed and/or the period of cycles lengthened in order to more finely scan a specific region of chemical space.

The microfluidics system 1, the first optical system 5 and the second optical system 6 may be components of a single device. The device may further comprise a controller for controlling the microfluidics system 1. The device may further comprise the memory in which the measurement data is stored and processing means required for obtaining the measurement data. The device may further comprise processing means for processing the measurement data to determine a phase boundary and/or for controlling the microfluidic system based on the measured data, as described above. For example, the device may comprise a microfluidic chip forming the microfluidic system 1, and/or suitable electronic and optical components forming the first and second optical systems 5, 6 and/or an integrated circuit forming the processing and control means. Accordingly, the device may be a lab-on-a-chip. In some embodiments, processing and/or control means may be provided by a separate device, such as a computer.

Below is a description of an example system demonstrating characterisation of the phase-behaviour of FUS protein, with significantly improved assay throughout and reduced sample consumption with respect to conventional experiments. The methodology described is applicable to the characterisation of protein liquid-liquid phase separation behaviour in general.

The method utilises droplet microfluidics to rapidly produce many micro-droplets, each of which can be considered a discrete microenvironment in which to study protein phase separation. By altering the input solution conditions, a broad range of phase-separation environments are produced rapidly in order to map LLPS behaviour over a wide region of chemical space. Acquisition of a phase diagram (FIG. 6) for the protein FUS, a protein central to the pathology of amyotrophic lateral sclerosis is demonstrated. Using the microfluidic platform, the phase boundary between phase-separated and homogeneous FUS solution is determined, as modulated by the small molecule 1,6-hexanediol, which is known to strongly interfere with LLPS behaviour.

FIG. 4 shows an example of a microfluidic droplet generation part 102 for the microencapsulation of FUS-GFP (GFP-tagged FUS) under a range of solution conditions. The generation part 102 functions by combination of the aqueous protein mixture with an immiscible fluorinated-oil continuous phase, containing surfactant to prevent droplet coalescence, at a T-junction 127. Prior to the junction 127, buffer, protein and 1,6-hexanediol solutions are combined in different ratios, to define the range of protein and 1,6-hexanediol concentrations scanned by the microfluidic platform. Flow control and mixing ratios for this example are shown in FIGS. 7 and 8.

Alexa647 dye (10 μM) was mixed with the 1,6-hexanediol solution, to provide a fluorescent marker for the intra-droplet 1,6-hexanediol concentration. A pre-programmed syringe pump 107 was used to control the input flow rates of the aqueous droplet components, enabling automated sampling of chemical space. Laminar flow prevents mixing of the assay components prior to encapsulation, before rapid mixing occurs after droplet generation. Droplets were then collected off-chip under a layer of mineral oil to prevent evaporation. Samples were collected for three minutes before undergoing fluorescence imaging analysis.

The concentration of FUS^{G156E}-EGFP and 1,6-hexanediol present in each droplet was determined by integration of volume-normalised EGFP (green fluorescent protein) and Alexa647 fluorescence, respectively. Phase separation was observed by the presence of discrete puncta in GFP fluorescence, whereas homogeneous droplet fluorescence indicated the absence of phase separation (FIG. 5). By combining the measured concentration of droplet FUS^{G156E}-EGFP and 1,6-hexanediol concentration with the presence or absence of phase separation, a phase diagram for the FUS^{G156E}-EGFP/1,6-hexanediol system was generated (FIG. 6).

1,6-hexanediol is known to strongly inhibit the formation of protein condensates, as expected, phase separation was observable only at low (<1% v/v) concentrations of 1,6-hexanediol, with FUS-GFP exhibiting a homogeneous phase at higher diol concentrations. Furthermore, a positive gradient in the phase boundary could be observed, illustrating an increased propensity for LLPS at higher FUS-GFP concentration in this region of phase-space.

Using this approach, the position of the LLPS phase-boundary was estimated by the generation of >300 independent measurements of FUS-GFP behaviour within five minutes (3 minutes droplet generation, 2 minutes imaging time). This assay throughput is significantly greater than that achievable by manual experiments, with the subsequent increase in the number of data points enabling an improved fitting of the position of the protein phase boundary.

FIG. 9 shows an example of a microfluidic droplet generation part 202 for the microencapsulation of FUS-EGFP (EGFP-tagged FUS) under a range of solution conditions. Droplets are generated using a flow-focussing microfluidic device controlled by automated syringe pumps 207 and then imaged in wells 230 by fluorescence microscopy. At the droplet generating junction 227, aqueous solutions are combined under laminar flow before droplet formation. FIG. 10 shows how the flowrates of the aqueous solutions are controlled by a programmed syringe pump system allowing a range of protein and modulator concentrations to be scanned. FIG. 11 shows brightfield microscopy image of droplet generation (left) and combined fluorescence images of droplet generation (right) showing fluorescence of EGFP (green/light grey) and Alexa647 (magenta/dark grey) barcodes for FUSG156E and PEG, respectively.

FIG. 12 (left/middle) show epifluorescence microscopy images of trapped microdroplets, with EGFP and Alexa647 fluorescence corresponding to FUSG156E and PEG concentration, respectively. FIG. 12 (right) shows classification of droplets as phase separated (dashed outline) or homogeneous (solid outline) according to distribution of EGFP fluorescence. FIG. 13 shows how liquid condensates merge over time (1 h) in microdroplets, demonstrating their liquid properties.

FIG. 14 shows a phase diagram of EGFP-FUSG156E vs. PEG 4000 concentration. Red/light grey (top right) and blue/dark grey (bottom left) data points in the scatter plot correspond to individual phase separated or homogeneous droplets, respectively. The heat map corresponds to the probability of phase separation as determined by an SVM classifier trained on the droplet scatter plot.

The number, size and shape of condensates contained within each microfluidic droplet may be determined via microscopy, and compared to the overall droplet volume to determine the volume fraction of the condensed phase within the droplet microenvironment. These parameters can be used to characterise condensate systems and can be determined as a function of the variable marked constituents in each micro droplet.

Coalescence of liquid-liquid phase separated condensates can be observed in the droplets over time and as a function of the barcoded chemical variables that constitute each droplet. Coalescence time can inform on physical characteristics of condensates such as surface tension and viscosity.

Biomolecular condensates exist as complex mixtures of different molecular components. By labelling these components separately, colocalization of different molecules to the same condensate can be observed. Such molecules can be proteins, nucleic acids, small molecules etc. In addition, microstructure within condensates can be observed where the local concentrations of the condensate components differ through the condensate volume. The relative amount of a co-localising molecule contained inside and outside of condensates (i.e. the partitioning coefficient) is a useful parameter that described the affinity of the molecule for the condensed phase. The partitioning coefficient can be determined on a drop-by-drop basis as a function of the system parameters.

Further optical techniques can be applied to the analysis of biomolecular condensates within the system including (list not exhaustive):

Fluorescence Recovery After Photobleaching (FRAP). This technique can inform on the diffusion rate of labelled molecules within condensates, which is informative of the liquid state of the condensate and the local viscosity.
Fluorescence polarisation spectroscopy.
Förster Resonance Energy Transfer (FRET).
Brillouin microscopy.

Summary: Biophysical characterisation of condensates as function of phasescan parameters
Size, number, volume fraction, aspect ratio (shape)
Coalescence kinetics
Colocalization of different molecules within the same condensate.
   Partitioning
   Multiphase characterisation
FRAP, polarisation spectroscopy etc
Material property states and viscoelastic properties

According to one example, the methods and systems described above may be used for screening therapeutic drug candidates. In that case, at least one constituent of the micro-droplets, other than the macromolecule, should comprise a drug candidate. Therapeutic drug candidates that fail to change the phase transition characteristics in a predefined desired way can be discarded. On the other hand, drug candidates that do change the phase transition characteristics in a predefined desired way can be retained for further investigation. Specifically, the intended therapy may be the treatment of a protein misfolding disease, such as motor neurone disease, Alzheimer's disease and/or some cancers.

Although the present invention has been described in terms of examples, it is not limited thereto. It should be appreciated that variations or modifications may be made to the examples described without departing from the scope of the present invention as defined by the claims.

1. A method measuring the phase transition characteristics of a macromolecule, the method comprising:
generating a stream of micro-droplets comprising at least one constituent, of which one constituent comprises the macromolecule,
varying the conditions in the micro-droplets; and
measuring the relative concentrations of the constituents of, and the phases of the macromolecule present in, the micro-droplets.

2. The method of any preceding claim, wherein the conditions in the micro-droplets are varied by varying the relative concentrations, in the micro-droplets, of the constituent comprising the macromolecule and at least one further constituent.

3. The method of claim 1, wherein the conditions in the micro-droplets are varied by varying the temperature of the micro-droplets.

4. The method of claim 2, wherein the temperature of the micro-droplets is varied by controlling the temperature of a channel in which the micro-droplets flow.

5. The method of any preceding claim, wherein the stream of micro-droplets is a continuous stream.

6. The method of claim any preceding claim, wherein the measuring is performed continuously on the stream of micro-droplets.

7. The method of any one of claims 1 to 6, wherein the micro-droplets are collected and measuring is performed on the collected micro-droplets.

8. The method of any preceding claim, wherein the stream of micro-droplets is generated by injecting a stream of a first fluid comprising the constituents into a stream of a second fluid, the second fluid being immiscible with the first fluid.

9. The method of claim any preceding claim, wherein the relative concentrations of the constituents of the micro-droplets are varied by varying relative flow rates of the respective streams of the at least two constituents of the micro-droplets.

10. The method of any preceding claim, wherein the relative concentrations of the constituents of the micro-droplets are measured by a first optical means.

11. The method of claim 10, wherein the first optical means illuminates the micro-droplets with illumination light and detects a response.

12. The method of claim 11, wherein the relative concentrations of the constituents of the micro-droplets are determined based on the respective responses of the constituents to the illumination light.

13. The method of claim 12, wherein each of the constituents whose relative concentrations are measured comprises a different fluorophore which emits light of a specific wavelength in response to the illumination light.

14. The method of any preceding claim, wherein the phases of the macromolecule present in the micro-droplets are measured by a second optical means.

15. The method of claim 14, wherein the second optical means obtains images of the micro-droplets and the phases of the macromolecule present in the micro-droplets are determined based on characteristics of the image indicative of particular phases.

16. The method of claim 14, wherein the second optical means obtains a light-scattering profile of the micro-droplets and the phases of the macromolecule present in the micro-droplets are determined based on characteristics of the light scattering profile indicative of particular phases.

17. The method of any preceding claim, wherein the relative concentrations of the constituents of the micro-droplets are varied based on the measured relative concentrations of the constituents of, and the phases of the macromolecule present in, the micro-droplets.

18. The method of claim 17, wherein the relative concentrations of the constituents of the micro-droplets are systematically varied so as to generate micro-droplets having conditions at which, or substantially close to which, the macromolecule transitions from a first phase to a second phase.

19. The method of any preceding claim, wherein the macromolecule comprises one or more of: a protein, and a nucleic acid.

20. The method of any preceding claim, wherein the at least two constituents further comprise one or more of: a pH buffer, a phase separator, a salt solution and a therapeutic drug/drug candidate.

21. A method of screening therapeutic drug candidates, the method comprising the steps of the method of any preceding claim, wherein at least one constituent of the micro-droplets, other than the macromolecule, comprises a drug candidate.

22. An apparatus for measuring phase transition characteristics of a macromolecule, the apparatus comprising:
a microfluidics system configured to generate a stream of micro-droplets comprising at least one constituent, of which one constituent comprises the macromolecule, and vary the relative concentrations of the constituents of the micro-droplets and/or the temperature of the micro-droplets; and
a first optical system configured to measure the relative concentrations of the constituents of the micro-droplets generated by the microfluidics system; and
a second optical system configured to measure the phases of the macromolecule present in the micro-droplets generated by the microfluidics system.

23. The apparatus of claim 22, wherein the microfluidics system comprises:
at least two inlets configured to input streams of respective constituents of the at least two constituents;
a first channel through which a stream of a first fluid is configured to flow, the first fluid comprising the at least two constituents from the at least two inlets; and
a second channel through which a stream of a second fluid is configured to flow, the second fluid being immiscible with the first fluid;
wherein the first channel comprises a nozzle opening into the second channel and configured to inject the stream of the first fluid into the stream of the second fluid and generate micro-droplets of the first fluid within the second fluid.

24. The apparatus of claim 23, further comprising at least two pumps corresponding to the at least two inlets, the at least two pumps being configured to vary the relative flow rates of the streams of the respective constituents so as to vary the relative concentrations of the at least two constituents of the generated micro-droplets.

25. The apparatus of claim 24, further comprising a controller configured to control the pumps to vary the relative concentrations of the constituents of the micro-droplets based on the measured relative concentrations of the constituents of, and the phases of the macromolecule present in, the micro-droplets.

26. The apparatus of claim 25, wherein the controller is configured to control the pumps so as to systematically vary the relative concentrations of the constituents of the micro-droplets so as to generate micro-droplets having conditions at which, or substantially close to which, the macromolecule transitions from a first phase to a second phase.

27. The apparatus of any one of claims 22 to 26, wherein the first optical system comprises:
a light source configured to illuminate the micro-droplets with illumination light; and
a detector configured to detect the response of the micro-droplets to the illumination light.

28. The apparatus of claim 27, wherein the light source comprises a plurality of light emitting parts each configured to emit light of a different wavelength.

29. The apparatus of claim 27 or 28, wherein the detector comprises a plurality of light detection parts each configured to detect light of a different wavelength.

30. The apparatus of any one of claims 22 to 29, wherein the second optical means comprises an imaging element configured to obtain images of the micro-droplets.

31. The apparatus of any one of claims 22 to 29, wherein the second optical means comprises:
a light source configured to illuminate the micro-droplets; and
a detector configured to obtain a light-scattering profile of light from the light source scattered by the micro-droplets.

32. The methods or apparatus of any one of any preceding claim, wherein the constituent comprising the macromolecule comprises one or more of: the macromolecule itself, a cell, a subcellular organelle, a cell lysate.

33. The methods or apparatus of any preceding claim, wherein the phase transition characteristics of two or more macromolecules are measured simultaneously, at least one constituent comprising a further macromolecule.
